(19) United States
(12) Patent Application Publication
(10) Pub. No.: US 2026/0317181 A1
(43) Pub. Date: Oct. 15, 2026

(54) METHOD FOR PRODUCING NANOSTRUCTURED MATERIALS WITH FORMULA MaQbSixOy, NANOSTRUCTURED MATERIAL COMPRISING NANOPARTICLES WITH FORMULA MaQbSixOy, AND COMPOSITIONS THEREOF

(71) Applicants: ADAMANTIO S.R.L., TORINO (IT); A.T. MARMO SERVICE S.R.L., RHO (MI) (IT)

(72) Inventor: Marco NICOLA, TORINO (IT)

(21) Appl. No.: 19/481,981

(22) PCT Filed: May 7, 2024
(86) PCT No.: PCT/IB2024/054421

§ 371 Date: Nov. 6, 2025

(30) Foreign Application Priority Data
May 8, 2023 (IT) 102023000009153

(51) Int. Cl. C01B 33/24

(52) U.S. Cl. CPC C01B 33/24; C01P 2002/85; C01P 2004/03; C01P 2004/64; C01P 2006/60

(57) ABSTRACT

The present invention relates to a method for producing nanostructures materials with formula MₐQ_{b}SiₓO_{y} wherein M is selected from the group consisting of Ca, Sr and Ba; Q is selected from the group consisting of Cu, Fe, Cr and Mg; a is 1 or 2, b is 1 or 2, x is 2 or 4, y is 6, 7, 8 or 10; comprising the steps of: mixing at least one solid nanostructured silica precursor, at least one source of M, and at least one source of Q in a weight ratio corresponding to the stochiometric ratio in the nanostructured material with formula MaQbSixOy to be produced; heating the mixture obtained in the previous step in air and conditions of room temperature and ambient pressure at a temperature from 700 °C to 1150 °C for a time from 5 minutes to 12 hours to obtain a pulverulent product; heating the pulverulent product for 2 to 5 minutes by means of microwaves once or more times. The invention also relates to the product obtained by this method and to compositions comprising this product.

### CROSS-REFERENCE TO RELATED APPLICATIONS

This Patent Application claims priority from Italian Patent Application No. 102023000009153 filed on May 8, 2023, the entire disclosure of which is incorporated herein by reference.

### Technical Field

The present invention relates to a method for producing nanostructured materials of formula MₐQ_{b}SiₓO_{y}, to a nanostructured material comprising nanoparticles of formula MₐQ_{b}SiₓO_{y}, and to compositions comprising the same.

### State of the Art

The ancient Egyptian blue (EB) pigment consists mainly of the very stable crystalline compound CaCuSi₄O10 (calcium copper tetrasilicate), a synthetic tetragonal silicate analogue of the rare mineral cuprorivaite. The pigment was developed over 5000 years ago and was widely used for about four millennia until its use mysteriously declined during the early Middle Ages. Recently, however, this compound has attracted a lot of attention along with some related materials, leading to a rapidly growing number of innovative applications in fields such as sensors, energy production and storage, energy saving and medicine. The new wave of interest began with the discovery of the intense near-infrared (NIR) photoluminescence produced by some of these materials, which can surprisingly also be triggered by relatively low-frequency light such as visible light and NIR. It has also recently been established that it is possible to exfoliate these materials and produce luminescent nanosheets in the NIR, expanding the family of 2D nanomaterials. Even more recently, the discovery of high biocompatibility, angiogenic and antibacterial effects, as well as very promising optical, electrical and magnetic properties, has further increased their potential for applications in future technologies.

The main compounds in this group of materials (to which the CaCuSi₄O₁₀ of EB also belongs) are part of the gillespite group and are generally silicates of the MQSi₄O₁₀ type where M=Ca, Sr or Ba and Q is an element in square planar coordination which is generally Cu but can also be Fe, Cr or Mg. However, there are also copper silicates and other alkaline earth elements that sometimes exhibit similar properties (e. g. luminescence or colour) such as BaCuSi₂O₆, BaCu₂Si₂O₇ and Ba₂CuSi₂O₇. It should be noted that BaCuSi₄O₁₀ is the main constituent of the ancient Chinese blue pigment (Han Blue) and is the synthetic analogue of the mineral effenbergerite, BaCuSi₂O₆ is the main constituent of the ancient Chinese purple pigment (Han Purple) and is the analogue of the mineral colinowensite, SrCuSi₄O₁₀ is the synthetic analogue of the mineral wesselsite and BaFeSi₄O₁₀ is the analogue of gillespite, which, being the first of these compounds to be found in nature, gives its name to the entire group of minerals. The components of the group containing Cr and Mg have been reported in literature as synthetic compounds, but no analogues have currently been found in nature.

To date, the potential of all these materials is not fully exploited due to several factors.

First of all, traditional syntheses (especially melt-flux syntheses) produce impure materials containing high fractions of amorphous or unreacted materials that result in Self-absorption and thus attenuation of photoluminescence.

Moreover, traditional melt-flux syntheses are the only ones applied on a large scale. This is mainly due to their simplicity compared to other syntheses.

Further, the other syntheses developed, i.e. solid-state, sol-gel, solution combustion, hydrothermal and pseudomorphosis, apart from requiring reagents or synthesis conditions that are more difficult to obtain, are not optimised to produce high-purity materials with high luminescence performance.

Further, currently known methods for the production of nanosheets of EB (and related compounds) are very slow, laborious and, above all, generally lead to a considerable reduction in the optical performance of materials.

To date, materials similar to those covered by the invention have been produced from suspended silica by sol-gel methods or by pseudomorphosis of NaRUB-18. However, these methodologies are generally complicated, involving the use of unsustainable reagents, the formation of intermediate gels or the manipulation of the silica source. More specifically, pseudomorphosis involves the manipulation of the solid source of silica (i.e. NaRUB-18), which is treated with copper acetate to obtain a theoretical CuRUB-18 that can then take part in the reaction. Pseudomorphosis produces a product consisting of flat particles with large lateral dimensions that is impure in Cuo and other unreacted residues, as can be deduced from the low total Cu content in the finished product. As far as sol-gel syntheses are concerned, these take place from liquid-phase silicon sources, generally in the form of colloidal solutions or silica particle formation precursors such as TEOS (Tetra Ethyl Ortho Silicate). In general, sol-gel syntheses do not focus on exploiting the structural properties of solid-phase silica sources, but silica is used in nanoscale dispersion form to improve its reactivity and to obtain intermediate xerogels that are then brought to high temperature. Such xerogels may contain residues (e.g. sodium or potassium in colloid stabilisers) that can lead to the formation of undesirable glassy phases. Neither the materials produced via pseudomorphosis nor those produced via sol-gel have been tested and/or optimised to obtain phases with high optical performance (i.e. high photoluminescence in the NIR), characteristics generally associated with low CuO and glassy phase residues. The first methodology for producing nanoparticles and nanosheets of these materials was developed in 2012 and has since been developed.

Finally, coupling systems and synergy with other materials have been given little or no consideration so far.

It is therefore an object of the present invention to provide a method for producing nanostructured materials that have more intense near-infrared photoluminescence and are simpler, faster and cheaper than known methods.

This object is achieved by the present invention as it relates to a method as defined in Claim 1.

It is a further object of the present invention to provide a nanostructured material as defined in claim 8.

It is also an object of the present invention to provide a composition as defined in claim 11.

### BRIEF DESCRIPTION OF THE FIGURES

FIGS. 1A and 1B represent, respectively, photographic image and a fluorescence image acquired by VIL (Visible Induced Luminescence) technique of commercial Egyptian blue samples, produced according to the invention and produced by conventional synthesis methods.

FIG. 2A shows an electron microscope image of a cuprorivaite obtained by the method according to the present invention.

FIG. 2B shows the EDS spectrum corresponding to the area in the box in FIG. 2A.

FIGS. 3A to 3C are electron microscope photographs of powders obtained by conventional synthesis and the method according to the present invention.

FIG. 4 is an electron microscope photograph of a powder obtained by the method according to the present invention.

FIG. 5 is an electron microscope photograph of the same powder in FIG. 4 further treated with microwaves and surfactant.

FIG. 6 shows the quantum yield comparison between two commercial samples of Egyptian blue, a sample produced by traditional melt-flux synthesis and Egyptian blue produced by the method according to the present invention.

FIG. 7 shows a photoluminescence analysis of several Egyptian blue samples and variants with progressive substitution of Mg for Cu.

FIGS. 8A and 8B are an SEM image and an EDS spectrum corresponding to the cry point of Mg-modified cuprorivaite, respectively.

FIG. 9 illustrates VIL images of normal and Mg-modified Egyptian Blue and Han Blue samples.

FIG. 10 illustrates some of the samples produced by solid-state cuprorivaite on masonry support.

FIG. 11 shows cuprorivaite Samples applied with different binders and in different concentrations.

FIG. 12 shows an image of the NIR fluorescence of the cuprorivaite samples shown in FIG. 11.

### DETAILED DESCRIPTION OF THE INVENTION

The method according to the invention for producing nanostructured materials of formula MₐQ_{b}SiₓO_{y} wherein which M is selected from the group consisting of Ca, Sr and Ba, Q is selected from the group consisting of Cu, Fe, Cr and Mg, a is 1 or 2; b is 1 or 2,

x is 2 or 4; and y is 6, 7, 8 or 10, comprises the following steps.

First, at least one solid, nanostructured silica precursor, at least one source of M, and at least one source of Q are mixed in a weight ratio corresponding to the stochiometric ratio in the nanostructured material with formula MₐQ_{b}SiₓO_{y} to be produced.

For example for CaCuSi₄O₁₀ the ratio of Si:Cu:Ca will be 4:1:1. In such cases, a slight excess of Si or alkaline earth elements does not result in a noticeable deterioration of the optical properties, while an excess of Cu can lead to the formation of compounds such as Cuo that cause the product to darken and its optical performance to decrease markedly.

The source of M (alkaline earth elements: Ca, Sr, Ba or a combination thereof) and the source of Q (e.g. copper) can be used either in the solid phase (e.g. as carbonates or oxides) or in the liquid phase (e.g. nitrates in aqueous solution). If all the reagents are in the solid phase, the addition of a small amount of deionised water can be useful to obtain a gelatinous paste of better consistency in order also to obtain better homogeneity characteristics of the mixture before the next step.

However, the reagents must be thoroughly mixed together before the next step.

Following the mixing step, the resulting mixture is heated in air and ambient pressure conditions to a temperature between 700 °C and 1150 °C to obtain a pulverulent product. The heating time can be very variable. After only a few minutes, satisfactory heating is achieved. Heating can be prolonged up to 200 hours. Preferably heating lasts from 5 minutes to 24 hours, even more preferably from 1 to 12 hours. At the end of the heating process, the resulting product is allowed to cool naturally to room temperature.

Contrary to previously developed syntheses, and in particular melt-flux (the most widely used), the product obtained at this stage has a powdery consistency and does not require intensive grinding. A similar result, in terms of consistency, is achieved with solid-state syntheses without flux. However, in general, the product obtained from solid-state syntheses is very impure due to a large proportion of unreacted silica that remains clearly visible in the central part of the particles of the product obtained. The presence of such unreacted silica is a consequence of the reduced interactions between the reactants during the solid-state reaction caused by the absence of a significant molten glassy phase. The method according to the present invention overcomes this limitation by using nanometric or nanostructured silica particles, enabling the total reaction of silica and its integral transformation into the corresponding silicates produced. Being able to limit the grinding phase also makes it possible, in general, to preserve the colour characteristics of the product (e.g. deep blue for CaCuSi₄O₁₀ or violet for BaCu₂Si₂O₇). Avoiding mechanical grinding protects the product from mechanical stress by preventing the introduction of reticular defects that can reduce optical performance such as NIR phosphor.

In a preferred embodiment, additives with melting properties can be added to the mixture. Examples are zinc (Zn), sodium (Na), potassium (K). These additives allow an improvement in colour properties and a reduction in production temperature.

The pulverulent product obtained in the heating step is finally heated for 2 to 5 minutes by microwaves one or more times, preferably 1 to 20 times, more preferably 5 to 15 times, even more preferably about 10 times.

Microwave heating takes place at a power of 350 watts, for example, with little or no mechanical agitation. Heating can also be interspersed with freezing steps.

One of the advantages of the method according to the present invention is that it considerably reduces lead times and costs. Known methods involved heating periods of several days or intensive procedures (e.g. ultrasound or ball milling) for several hours. With the method according to the invention, on the other hand, size reduction and exfoliation are achieved after only a few minutes. Size reduction is also achieved with little or no mechanical grinding. This is a key point as the physical stress on the material, induced by mechanical grinding, introduces reticular defects that affect optical performance as phosphors.

With regard to the silica precursor, which must be solid and nanostructured, it is preferable that the amount of impurities that may be present should be minimal and in particular that the reagents should be as free as possible of elements that may produce NIR-absorbing compounds (e.g. Fe) and of Na, K or other elements that may act as fluxes and thus lead to the melting of the silica and the formation of undesirable glassy phases. In fact, the presence of the glassy phase (particularly if it is rich in elements such as copper itself) can affect the optical characteristics of the product obtained.

Preferably, the method also includes the step of mixing the pulverulent product with at least one surfactant before the heating step.

The surfactant is preferably selected from the group consisting of:
CONTRAD 2000,
anionic surfactants, preferably sodium or potassium salts of fatty acids, sodium lauryl sulphate (SLS), ammonium lauryl sulphate (ALS) ;
cationic surfactants, preferably cetrimonium bromide (CTAB) or benzalkonium chloride;
non-ionic surfactants, preferably BRIJ-35 (non-ionic surfactant containing polyethoxylate lauryl ether), TWEEN-20 (non-ionic surfactant of the polysorbate type);
amphoteric surfactants, and
mixtures thereof.

The choice of surfactants used in the exfoliation step can change the surface characteristics of the particles by modulating their hydrophilic/lipophilic character and thus making them suitable for coupling with different polymers.

This embodiment has the dual result of decreasing the particle size and coating them with the lipophilic or hydrophilic agent, which facilitates their coupling with other materials (e. g. polymers for use in LSC) or enhances their use in certain applications such as forensics.

Preferably, the method also comprises a step of washing the mixture obtained in the mixing step with a dilute solution of strong acid. As mentioned earlier, an excess of Q, e.g. Cu, causes a decrease in the optical performance of the final product. For this reason, it is preferable to wash the mixture in dilute solutions of strong acids (e.g. hydrochloric or nitric acid) to remove any residual Q-oxide, e.g. Cuo.

The solid nanostructured silica precursor is preferably diatomite, phytolite or synthetic amorphous silica (SAS). More preferably, synthetic amorphous silica is selected from the group consisting of micronised colloidal silica SiO₂ (Aerosil), a mixture of air and amorphous silica (Aerogel, e. g. a mixture of 98% air and 2% amorphous silica), and silica gel.

Preferably, the solid nanostructured silica precursor, the at least one source of M, and/or the at least one source of Q are derived from waste materials or rejects.

Sources of micro- or nanostructured silica can be obtained from phytoliths present in the ash produced by plant species (e.g. grasses such as maize or bamboo) or from processing waste e.g. rice.

Cu, on the other hand, can be obtained e.g. from recycling of waste electrical and electronic equipment (WEEE), while Ca can be obtained from waste powders in many productions (e.g. marble processing, egg shells, etc.) . The recycled materials used are preferably refined in order to limit the introduction of undesirable impurities of elements that can either absorb part of the NIR emitted by the final product (e.g. Fe) or behave as fluxes and produce glassy phases leading to self-absorption (e.g. Na, K).

In a preferred embodiment MₐQ_{b}SiₓO_{y} comprises CaCuSi₄O₁₀. MₐQ_{b}SiₓO_{y} is preferably CaCuSi₄O₁₀.

According to another preferred embodiment MₐQ_{b}SiₓO_{y} comprises BaCuSi₄O₁₀ and/or BaCuSi₂O₆.

According to another embodiment, in MₐQ_{b}SiₓO_{y} a weight percentage of 10% to 30% of Q is Mg and the remaining weight percentage is Cu (with respect to the total weight percentage of MₐQ_{b}SiₓO_{y}), so that the nanostructured material produced is a mixture of CaCuSi₄O₁₀ and CaMgSi₄O₁₀. This further reduces the possibility of the formation of unwanted Cu by-products. The effect on luminescence loss can be very limited and the final product is even more economical and sustainable. The introduction of Zn, on the other hand, results in the formation of a generally undesirable glassy phase and thus reduces the luminescence of the final product. However, it may be useful to optimise certain characteristics of the final product (e.g. colour, chemical resistance or biocide properties).

The nanostructured material produced by the aforesaid method has a special structure that gives it enhanced photoluminescence. In fact, the method described makes it possible to obtain nanoparticles with a lamellar structure and reduced size and, in general, a product with reduced impurities and high optical performance due to the less destructive particle fragmentation process involving the interaction of fewer reagents.

The nanostructured material according to the invention thus comprises nanoparticles of formula MₐQ_{b}SiₓO_{y} wherein M is selected from the group consisting of Ca, Sr and Ba; Q is selected from the group consisting of Cu, Fe, Cr and Mg; a is 1 or 2, b is 1 or 2, Si is 2, 4, O is 6, 7, 8 or 10; the nanoparticles having lamellar structure and size from 1 nm to 5 μm.

The nanoparticles having lamellar structure have lamellae with thickness <100 nm.

The nanostructured material according to the invention is pulverulent and consists of weakly or not at all cohesive particles. Weak impurities may occasionally be present on the outside of the particles or between the individual lamellae (e. g. very small residues of glassy phase barely perceivable to SEM-EDS). The thickness of the individual lamellae is often preferably in the hundreds of nanometres range, but after exfoliation it is mostly less than 100 nanometres. The continuation of exfoliation is generally associated with an increase in the fraction of nanometer-sized particles. Exfoliation only acts on one of the dimensions (the thickness). It is possible to act on the other dimensions by acting on the synthesis conditions (cooking, heating and cooling times, structure of the starting silica) or alternatively by acting after the synthesis such as grinding, or by using agents capable of chemically or physically breaking up the particles (e.g. heat shock, ultrasound). In a preferred embodiment of the present invention, the use of heat shock has also been used in some samples. In another embodiment, ultrasound was used instead.

MₐQ_{b}SiₓO_{y} is preferably MQSi₄O₁₀, even more preferably it is CaCuSi₄O₁₀.

In an alternative embodiment MₐQ_{b}SiₓO_{y} is selected from the group consisting of BaCuSi₂O₆, BaCu₂Si₂O₇, Ba₂CuSi₂O₇, SrCuSi₄O₁₀, and BaFeSi₄O₁₀.

In the event that MₐQ_{b}SiₓO_{y} is CaCuSi₄O₁₀, a weight percentage of 10 % to 30 % of Q can be Mg instead of Cu, so that the nanostructured material is a mixture of CaCuSi₄O₁₀ (90-70 % of the total MₐQ_{b}SiₓO_{y}) and CaMgSi₄O₁₀ (10-30 % of the total MₐQ_{b}SiₓO_{y}).

Preferably, the solid nanostructured silica precursor is a waste material, preferably rice husk ash, more preferably rice husk ash.

In fact, rice has a husk made of a silica-rich organic substance (phytoliths), rice husk. this substance can be used as fuel. The ash resulting from combustion is generally considered a waste material and is formed in very large quantities. This is why it is particularly advantageous to use it as a solid nanostructured precursor to silica: this allows a waste material to be used as a raw material to produce a valuable substance. It is also possible to treat the ash to further refine it.

The present invention also relates to compositions comprising the nanostructured material described above.

Compositions preferably comprise natural or synthetic paint binders.

Examples of compositions are cement, glass, paints, tiles, metals, plastics, resins, composite materials, fabrics in which the material is bound (e.g. to produce masks and gowns).

In many cases, it is necessary to use appropriate anchoring systems for the materials produced on the substrates. The anchoring systems can be based on natural materials such as proteins, polysaccharides, lipids or oils; synthetic materials such as acrylic, vinyl, alkyd, hydrocarbon, urea and urethane, siloxane and silicone resins, nitrocellulose-based, cellulose-modified, ethyl silicate-based, alkylalkoxy silane-based, silicate-based; in both aqueous and solvent-based mediums.

### EXAMPLES

### Example 1

Various samples of copper silicates and alkaline earth elements produced mostly from Aerosil 200 were synthesised and characterised, but also from other types of nanostructured silica (e.g. hydrophobic Aerogel Aspen in pellets) and from micronised commercial grade silica, generally not nanostructured (Chimica Strola Turin). Conventional syntheses were performed in order to be able to compare the method according to the present invention and those currently most widely used (melt-flux) as well as with conventional solid-state synthesis methods. Comparisons were also made with commercial products currently on the market (Kremer Pigmente and Natural Pigments). For melt-flux syntheses, quantities of between 3 and 10 wt % Na₂CO₃ were used as the flux, and the reaction was similarly carried out for about 8 hours at temperatures of about 900 °C (compared to 1000 °C for conventional solid-state and syntheses according to the present invention).

As Ca and Cu sources, the corresponding carbonates (Sigma-Aldrich) were used in stoichiometric quantities in all cases. For traditional comparison syntheses, several heating steps to reaction temperature (usually 3 or 4) were carried out, interspersed with cooling and mechanical grinding. After the first step, flushes in HCl (approx. 50 ml 1M HCl per 5 g product and overnight with a final rinse in deionised water and annealing) were also used to eliminate unreacted by-products (CuO).

Compared to traditional syntheses, it was found that with the method according to the invention, acid flushing and further heating steps appear to provide little or no advantage in terms of luminescence, although a limited margin of improvement following acid flushing (HNO₃) is noted.

### Example 2

For the macroscopic assessment of the near-infrared luminescence of the products used, the Visible Induced Luminescence (VIL) technique was used.

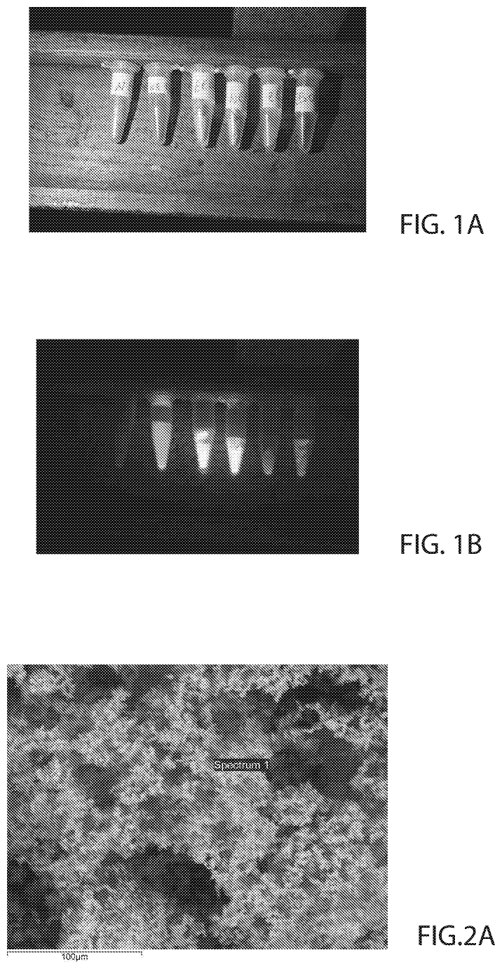

FIGS. 1A and 1B show the comparison of the visible and luminescence characteristics of commercial EB and produced with different techniques. FIG. 1A is a photographic image, while FIG. 1B is a fluorescence image acquired with the Visible Induced Luminescence (VIL) technique. The camera used is an EOS 400D digital camera from which the IR filter was removed. The sensitivity of the camera is up to 1000 nm. The VIL images were produced using a B+W IR filter BW72487 that allows no more than 1% of the radiation at 800 nm to pass through to 88% at 900 nm. An LED lamp (YONGNUO YN300) with very low emission in the infrared (IR) range was used as the light source. The samples shown from left to right in the two pictures are 1) Commercial sample “Natural Pigments”; 2) Commercial sample “Kremer Pigmente 120-10060”; 3) Sample EE0 produced by the method according to the invention; 4) Sample NEE0 produced and exfoliated by the method according to the invention; 5) Sample ZE4 produced by conventional solid-state synthesis; 6) Sample EB0 produced by conventional melt-flux synthesis.

The clearly superior optical performance of the samples produced by the method according to the invention is evident. In particular, it can be seen that the exfoliated sample (fourth from the left) has extraordinary luminescence characteristics.

### Example 3

The SEM-EDS (scanning electron microscope-energy dispersive spectroscopy) technique was used for morphological and compositional analysis at the micrometer and nanometer level.

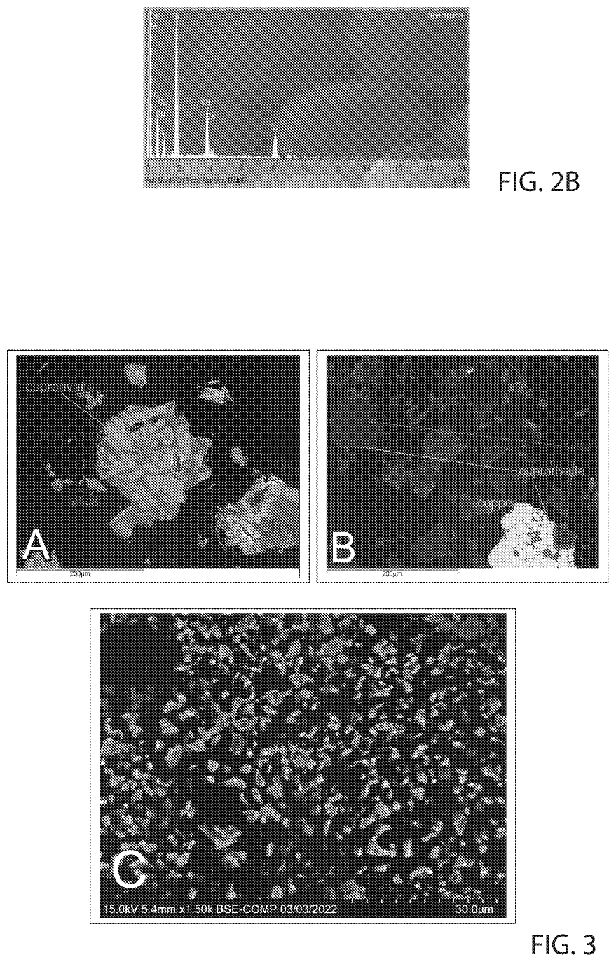

FIG. 2A shows the appearance of one of the powders obtained (sample FE0) under an electron microscope. FIG. 2B shows the EDS spectrum corresponding to the area in the box. The EDS spectrum highlights the high purity of the cuprorivaite produced.

FIGS. 3A to 3C show a comparison of powder cross-sections obtained by A) conventional melt-flux synthesis, B) conventional solid-state synthesis and C) the method according to the present invention (sample EE0LN). In image A, the glassy matrix and part of the unreacted silica is evident. Large quantities of unreacted material (silica and copper) are evident in image B. In particular, it is evident how the silica particles of the reagent are only covered with a thin layer of product (cuprorivaite) while the central part retains all or part of its original structure and chemical nature. FIG. 3C shows that the product has a much smaller particle size and that even at much higher magnification the particles consist almost entirely of only the cuprorivaite phase with a characteristic lamellar structure.

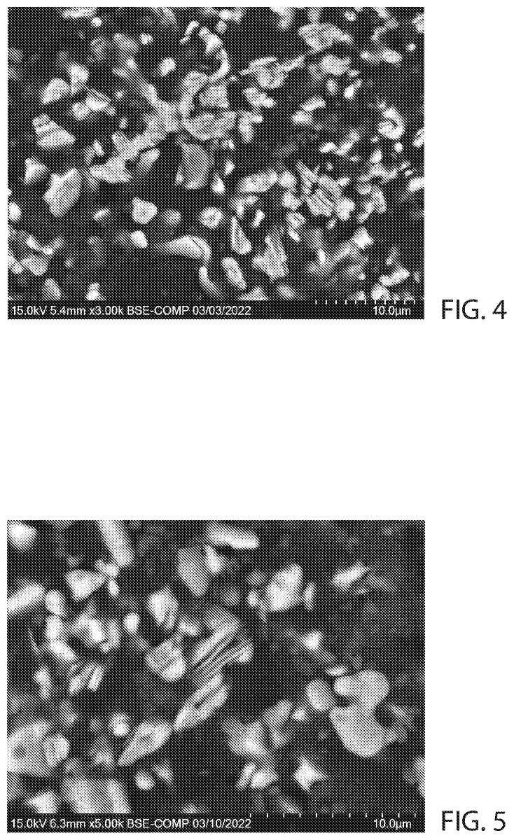

FIG. 4, related to sample EE0 and acquired at a higher magnification than the previous ones, shows the lamellar structure of the cuprorivaite produced. This structure is in agreement with the known characteristics of copper silicates and alkaline earth elements that are described in literature. Note the thickness of the discernible lamellae in the sample. These are far less than a micron in size and in some cases well below hundreds of nanometres, making the material produced fully within the range of nanomaterials even before any exfoliation operation.

FIG. 5 is an image of the sample EE0 after exfoliation according to the present invention. The image is in fact acquired on the same sample after two 3-minute series of exfoliation at 700W in Contrad 2000 and shows that the fraction of sub-micron particles has clearly increased. Note that FIG. 5 is acquired at a much higher magnification than FIG. 4.

### Example 4

Reflectance spectroscopy was used to determine the optical properties and quantum yield.

The photoemission spectra and quantum yields were acquired with a HORIBA Scientific Fluorolog spectrofluorometer, equipped with a 450 W Xenon lamp, a Quanta-φ integrating sphere and two detectors: a Hamamatsu R928 photomultiplier for measurements in the visible region and a cooled InGaAs liquid nitrogen photodiode for measurements in the NIR region. The spectral response was corrected for the spectral sensitivity of the detectors.

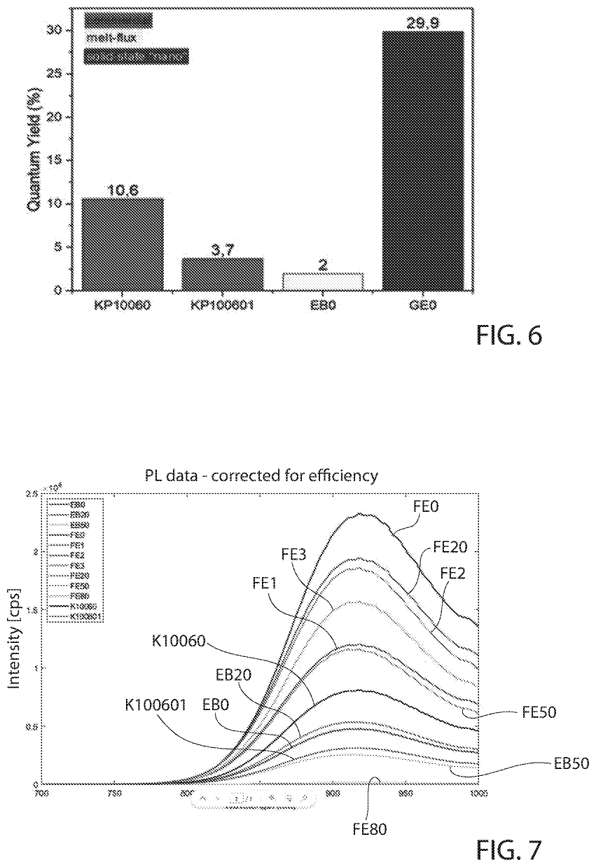

FIG. 6 (Quantum Yield) shows an illustrative comparison of two commercial samples (Kremer 120-10060 and Kremer 10-100601), a sample produced by conventional melt-flux synthesis (EB0) and the GE0 sample produced by the method of the invention. As is evident, GE0 has a Quantum Yield that is almost three times that of the best commercial product.

In FIG. 7 (Photoluminescence), a sample produced by the method of the invention (FE0) is compared with: commercial samples (Kremer 120-10060 and Kremer 10-100601), samples according to the invention with slight variations in the preparation (FE1, FE2 and FE3), samples according to the invention with progressive substitution of Mg for Cu (FE20, FE50 and FE80—20%, 50% and 80% substituted, respectively) and samples produced by conventional melt-flux synthesis (EB0) also variously substituted (EB20 and EB50 with 20% and 50% substitution of Mg instead of Cu, respectively). As can be seen, the innovative samples have far superior optical performance. It may be interesting to note that even samples according to the invention that have only 50% of the copper required for complete synthesis are still more luminescent than the best available commercial products.

### Example 5

Copper silicates belonging to the gillespite group were synthesised using melt-flux synthesis and solid-state synthesis procedures in order to obtain particles of a shape and size that would improve their characteristics (optical, luminescence, dimensional, etc.) Subsequently, the particles were characterised using the techniques: FT-IR Spectroscopy, Electron Microscopy Coupled with Microprobe (SEM-EDS) and X-Ray Diffractometry. Optical properties were assessed by Visible Induced Luminescence Imaging (VIL).

The materials synthesised were as follows.

A) The synthetic analogue of Cuprorivaite (CaCuSi₄O₁₀), which is also the main component of the pigment known as Egyptian Blue.

B) The synthetic analogue of Effenbergerite (BaCuSi₄O₁₀) which is also the main component of the pigment known as Han Blue.

C) The synthetic analogue of Colinowensite (BaCuSi₂O₆) which is also the main component of the pigment known as Han Violet.

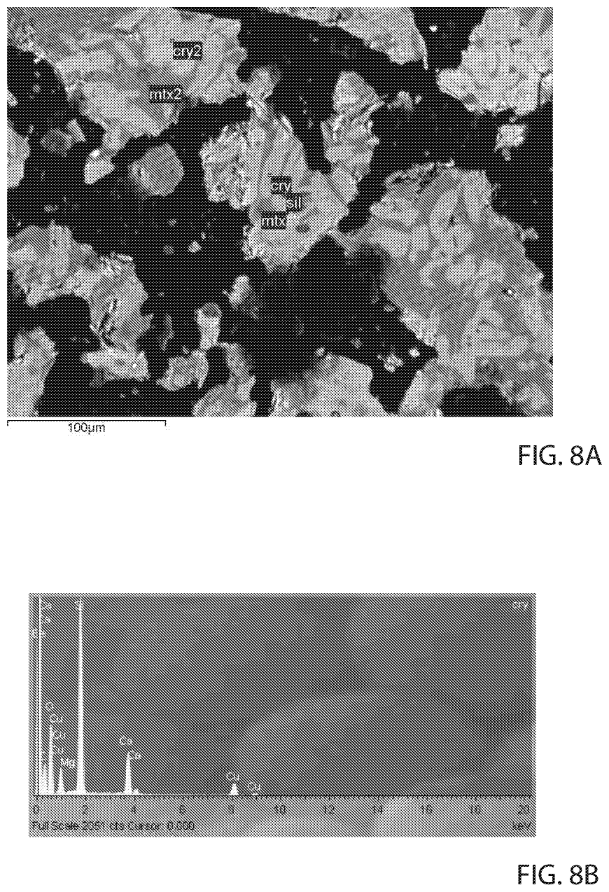

Two series of their modifications were also produced by progressive partial substitution of Mg in place of Cu. FIGS. 8A and 8B are an SEM image and an EDS spectrum corresponding to the cry point, respectively. The spectrum clearly shows the presence of magnesium within the modified cuprorivaite crystal obtained by melt-flux synthesis.

The products were synthesised in several procedures and were compared with each other and with the types currently commercially available (KREMER Melt-Flux Egyptian Blue <120 μm-KREMER Melt-Flux Egyptian Blue <10 μm-KREMER Melt-Flux Han Blue).

Each material had at least three firing cycles that took place at 900 °C for materials produced by melt-flux synthesis and at 975 °C for materials produced by solid-state synthesis.

After the first firing cycle, all materials produced by melt-flux synthesis were ground and left for 24 hours to react with approximately 50 ml of 1 M HCl in order to limit the amount of unwanted by-products and reagent residues. Instead, solid-state synthesis according to the present invention made it possible to skip this step. To verify the effectiveness of the synthesis, direct comparisons were also made between products obtained with and without immersion in HCl.

Two sets of samples were produced, one relating to Egyptian Blue and one relating to Han Blue. The samples in both series were produced with different degrees of Mg++/Cu++ substitution:

0% (pure Egyptian Blue or pure Han Blue), 20%, 50%, 80% and 100% substitution. On VIL analysis, the 100%-substituted samples show (predictably) no luminescence. The 80% substituted samples show high luminescence in the case of Han Blue and limited luminescence in the case of Egyptian Blue. The 0%, 20% and 50% substituted samples all show high luminescence.

The samples were produced both in glassy matrix (traditional or melt-flux synthesis) and in nanostructured form (solid-state synthesis, without glassy matrix). In the case of the latter, the luminescence is clearly superior to that of compounds obtained by melt-flux synthesis as shown by the Visible Induced Luminescence images. The comparison also with commercial samples (Kremer) is quite clear showing that the products we obtained show superior luminescence.

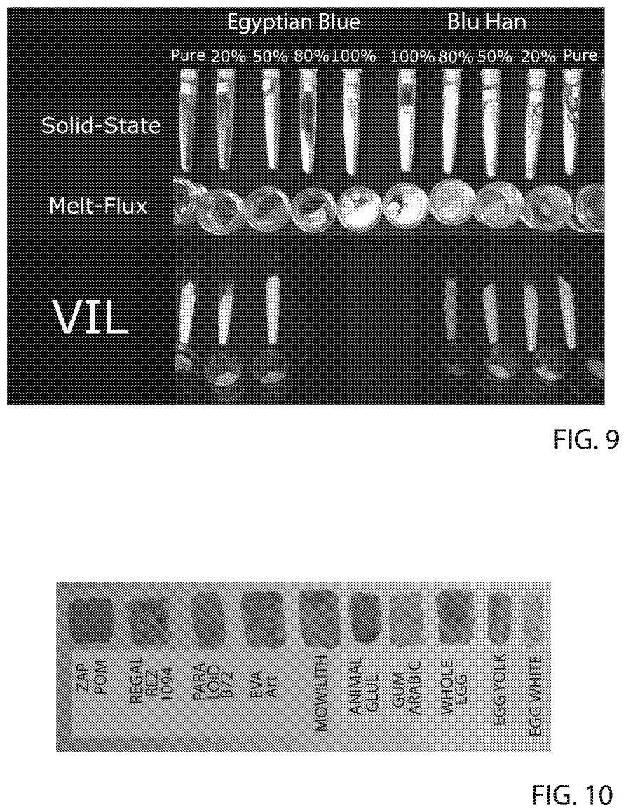

FIG. 9 shows samples of normal and Mg-modified Egyptian Blue and Han Blue. At the bottom, the image VIL shows the luminescence properties of the samples produced.

However, the presence of limited amounts of magnesium (20% and 50%) in melt-flux syntheses seems to improve the luminescence of the products, probably due to a decrease in self-absorption effects.

In total, the following samples were produced and characterised:
Melt-Flux Synthesis
5 Han Blue samples (different % magnesium substitution)
5 Egyptian Blue samples (different % magnesium substitution)
Solid-State SYNTHESIS
5 Han Blue samples (different % magnesium substitution)
5 Egyptian Blue samples (different % magnesium substitution)

For the latter type of synthesis, two samples of the Han Purple line were also produced, one 0% substituted and one 50% substituted.

SEM-EDS analyses conducted showed that in samples with a high magnesium content, other mineralogical phases are also generally detectable (in samples from melt-flux synthesis, some were recorded by SEM, although in general the excesses tend to stay in the amorphous phase in the glassy matrix rather than crystallising).

### Example 6

Compositions were produced and characterised to increase the effectiveness of additives and coatings, in particular to produce safe, sustainable and long-lasting active surfaces.

The results obtained with natural and synthetic binders are compared. The latter have proven to be more suitable for producing materials with significant optical and strength characteristics, although promising results have also been obtained from the use of natural binders, which could be particularly suitable for those procedures where high durability is not required and the use of toxic or excessively persistent compounds must be avoided. Formulations with different concentrations and starting materials were produced in order to optimise the products and achieve improvements over previously known possibilities.

In particular, varnishes and paints based on copper silicates belonging to the gillespite group produced by melt-flux synthesis and solid-state synthesis procedures were formulated. A series of natural and synthetic binders were tested in order to allow adhesion to the substrate without affecting the characteristics the nanostructured materials (chromatic, luminescence, structural, etc.).

After a general screening of all possible binders (including acrylics, siloxanes, alkoxysilanes, etc.), research focused on a few specific binders:

### A) SYNTHESIC

Zappon (i.e. nitrocellulose in nitro thinner)
Regalrez 1094 (hydrogenated oligomers of vinyl-toluene and alpha-methyl-styrene in petroleum ether)
Paraloid B72 (acrylic resin consisting of methylacrylate/ethylmethacrylate copolymer in dowanol PM)
EVA Art (aqueous dispersion of ethylene vinyl acetate resin)
Mowilith DM230 (aqueous dispersion of copolymer based on vinyl acetate and vinyl ester of versatic acid).

### B) NATURAL

Animal glue (i.e. collagen)
Gum arabic (i.e. polysaccharides)
Egg (i.e. egg white albumin and egg yolk phosphoproteins).

FIG. 10 shows some of the samples produced by solid-state cuprorivaite on wall support.

The products were formulated at different concentrations and with different procedures and were compared with each other in order to identify the determining factors for optimising the optical characteristics.

Each formulation was composed of copper silicates from the gillespite group (mainly cuprorivaite, effenbergerite and wesselsite) that had undergone at least three heating cycles to 900 °C for materials produced by melt-flux synthesis and to 1000 °C for materials produced by solid-state synthesis.

The effectiveness of the anchoring systems was assessed by verifying the effective adhesion of photoluminescent products in infrared (a characteristic of cuprorivaite and related materials). The Visible Induced Infrared Luminescence (VIL) imaging technique was used for this purpose.

The compositions formulated were cuprorivaite-based and effebergerite-based. The formulations in both series were produced with different types and concentrations of binders and dispersed in appropriate solvents.

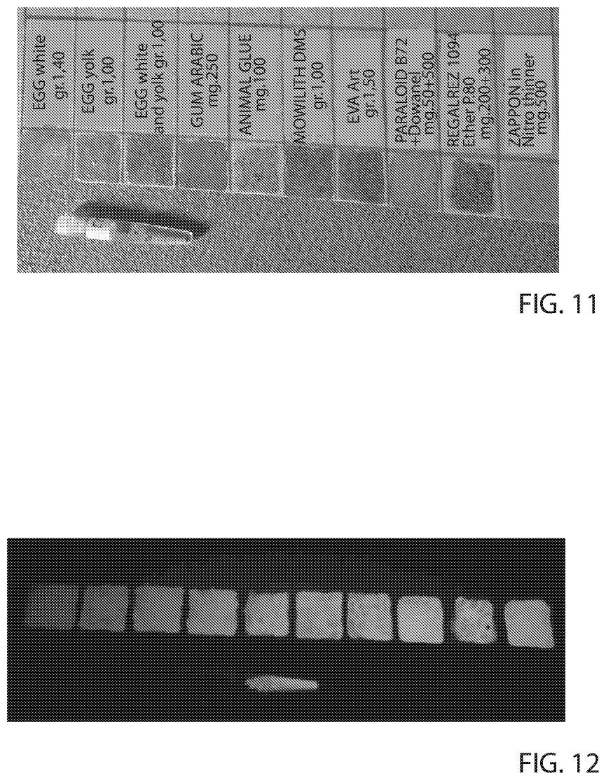

FIG. 11 shows cuprorivaite samples applied with different binders and in different concentrations.

In particular, low-impact solvents were chosen in preference to water wherever possible.

All the applied binders resulted in slight colour alteration. In particular, egg yolk interferes with the natural colouration of copper silicates by shifting their hue towards green while Regalrez, EVA Art and Mowilith increase the saturation of the compounds by shifting the hue from light blue to deep blue.

The Visible Induced Luminescence analyses conducted showed that the presence of the binders does not significantly affect the infrared photoluminescence of copper silicates of the gillespite group. As shown in FIG. 12 (NIR fluorescence image of cuprorivaite samples applied with binders of different nature and in different concentrations as shown in FIG. 11), the least interfering formulation appears to be Paraloid B72 but good results were also obtained with Zappon. Among the water-based compounds, EVA Art and Mowilith performed well, while among the natural ones, gum arabic was the best.

### Advantages

The method according to the invention makes it possible to obtain particularly small nanoparticles and nanosheets by means of microwave exfoliation. This procedure is fast, economical and environmentally sustainable, because it uses raw materials that are widely available, non-polluting and possibly also the result of recycling waste from other productions.

In addition, as unlike the methods in use in the state of the art, the method according to the invention does not involve prolonged agitation with stirrers, ultrasound or mechanical grinding, the formation of defects is reduced and the optical performance of photoluminescence is better preserved even in nanosheets. The method according to the invention also has great advantages in terms of production time and energy used.

In addition, the use of surfactants produces even better results. In particular, the choice of surfactants used in the exfoliation step can change the surface characteristics of the particles by modulating their hydrophilic/lipophilic character and thus making them suitable for coupling with different polymers. The optical and chromatic properties of the particles are influenced by the refractive index of the binders used. The silicates used in the invention have, in general, a planar structure and are dichroic (i.e. show two distinct colours when observed in different orientations under polarised light) and therefore have two distinct refractive indices (RI). The covering power and saturation of pigments depend on the difference between their RI and that of the binder. EB, for example, has RIs of 1,636 w (ordinary radius, electric field perpendicular to the c-axis) and 1,591 e (extraordinary radius). Fairly similar values are recorded by other members of the group. According to the invention, it has been demonstrated that the combination with certain binders can improve colour and optical performance.

The product obtained by the method according to the invention has low amorphous component content and high optical performance, i.e. it is capable of producing far more intense near-infrared photoluminescence than currently available silicate analogues.

The increase in optical performance is attributable to the following factors:
A) Increased purity of the products obtained. The products are free from self-absorbing impurities (such as unreacted Cu compounds, Fe, etc.)
B) Absence or very limited presence of glassy phase which, especially if containing Cu (as in traditional melt-flux synthesis) is also capable of producing self-absorption.
C) Lower incidence of defects in the luminescent material due to less or no need to physically or ultrasonically grind the material (which is already pulverulent at the end of the synthesis).

1. A method for producing nanostructured materials with formula MₐQ_{b}SiₓO_{y}
wherein
M is selected from the group consisting of Ca, Sr and Ba;
Q is selected from the group consisting of Cu, Fe, Cr and Mg;
a is 1 or 2
b is 1 or 2
x is 2 or 4,
y is 6, 7, 8 or 10;
comprising the steps of
mixing at least one solid nanostructured silica precursor, at least one source of M, and at least one source of Q in a weight ratio corresponding to the stochiometric ratio in the nanostructured material with formula MₐQ_{b}SiₓO_{y} to be produced;
heating the mixture obtained in the previous step in air and conditions of room temperature and ambient pressure at a temperature from 700 °C to 1150 °C to obtain a pulverulent product;
heating the pulverulent product for 2 to 5 minutes by means of microwaves once or more times.

2. The method according to claim 1, further comprising a step of mixing the pulverulent product with at least one surfactant before the step of heating the mixture.

3. The method according to claim 2, wherein the at least one surfactant is selected from the group consisting of:
CONTRAD 2000,
anionic surfactants, preferably sodium or potassium salts of fatty acids, sodium lauryl sulphate (SLS), ammonium lauryl sulphate (ALS),
cationic surfactants, preferably cetrimonium bromide (CTAB) or benzalkonium chloride,
non-ionic surfactants, preferably BRIJ-35 (non-ionic surfactant containing polyethoxylate lauryl ether), TWEEN-20 (non-ionic surfactant of the polysorbate type),
amphoteric surfactants, and
a mixture thereof.

4. The method according to claim 1, further comprising a step of washing the mixture obtained in the step of mixing with a diluted solution of strong acid.

5. The method according to claim 1, wherein the solid nanostructured silica precursor is diatomite, phytolith, or synthetic amorphous silica (SAS), the synthetic amorphous silica being preferably selected from the group consisting of micronized colloidal silica SiO₂ (Aerosil), a mixture of amorphous silica (Aerogel), and silica gel.

6. The method according to claim 1, wherein MₐQ_{b}SiₓO_{y} comprises CaCuSi₄O₁₀, preferably CaCuSi₄O₁₀.

7. The method according to claim 6, wherein a weight percentage from 10 % to 30% of Q is Mg and the remaining weight percentage is Cu with respect to the total weight percentage of MₐQ_{b}SiₓO_{y}, so that the nanostructured material is a mixture of CaCuSi₄O₁₀ and CaMgSi₄O₁₀.

8. A nanostructured material produced by the method according to claim 1, comprising nanoparticles of formula MₐQ_{b}SiₓO_{y}
wherein
M is selected from the group consisting of Ca, Sr and Ba;
Q is selected from the group consisting of Cu, Fe, Cr and Mg;
a is 1 or 2
b is 1 or 2
x is 2, 4,
y is 6, 7, 8 or 10;
the nanoparticles having a lamellar structure and a size of 1 nm to 5 μm, and wherein said nanoparticles have lamellae <100 nm thick.

9. The nanostructured material according to claim 8 having photoluminescence >about 10.6 quantum yield %.

10. The nanostructured material according to claim 8, wherein the solid, nanostructured silica precursor is a waste material, preferably rice husk, more preferably rice husk ash.

11. A composition comprising the nanostructured material according to claim 8.

12. The composition according to claim 11, comprising natural or synthetic pictorial binders.
